(19) United States
(12) Patent Application Publication
(10) Pub. No.: US 2006/0043818 A1
(43) Pub. Date: Mar. 2, 2006

(54) Motor casing

(75) Inventor: Jui Kun Chen, Taichung Hsien (TW)

Correspondence Address: BACON & THOMAS, PLLC, 625 SLATERS LANE, FOURTH FLOOR, ALEXANDRIA, VA, 22314, US

(73) Assignee: REXON INDUSTRIAL CORP., LTD., Taichung Hsien (TW)

(21) Appl. No.: 11/011,089

(22) Filed: Dec. 15, 2004

(30) Foreign Application Priority Data
Aug. 27, 2004 (TW) 93213654

(51) Int. Cl. H02K 5/00; H02K 13/00; H01R 39/38; A47L 5/24

(52) U.S. Cl. 310/239; 310/89

(57) ABSTRACT

A motor casing includes a first half and a second half which is connected to the first half along a longitudinal direction of the motor casing. A stator and a rotor with a commutator are received in a space enclosed by the first and second halves. A shaft is connected to an driving shaft on the rotor. Two recesses are defined in the second half and two sets of brush units are received in the two recesses. A U-shaped brush cover is connected to the first half and two distal ends of the brush cover seal the two recesses.

### FIELD OF THE INVENTION

The present invention relates to a motor casing composed of two halves and two brush units are respectively received in two recesses in one of the halves. The brush units are conveniently accessed by removing one of the halves.

### BACKGROUND OF THE INVENTION

As shown in FIGS. 1 and 2, a conventional power tool such as table saw uses a motor as a power source to drive the blade and the motor 10 is received in a casing 11 which is connected to the frame of the power tool. The conventional motor casing 11 is a tubular member with an open end 111 and a close end 112, wherein the stator 12, rotor 13 and the accessories 15 are installed in the casing 11 via the open end 111. The shaft 14 extends through the open end 111 and is connected to the motor 10 so as to output power. An aluminum frame 16 is connected to the open end 111 of the casing 11 and a bracket 17 is connected to the close end 112 of the casing 11. By the bracket 17 and the frame 16, the motor 10 and the casing 11 are connected to the power tool. Two radial holes 113 are defined through the casing 11 and located close to the close end 112 so as to respectively receive a brush housing 18, a brush set 19 including a brush 192 with a brush spring 191, and an end cap 181 for sealing the radial hole 113 therein. The brush 192 is in contact with the commutator 131 on the rotor 13 so as to generate electric current. It is not convenient for the assemblers to install all the parts into the casing 11 from the open end 111 because some of the parts have be positioned in a deep position in the casing 11. Besides, the brush 192 needs to be maintained after being used for a period of time or replaced. Because the two radial holes 113 are located in opposite to each other so that the users have to disassemble the brush units respectively and this is a time-consuming job.

The present invention intends to provide a motor casing that is composed of two halves and the two sets of brush units can be accessed simultaneously after a brush cover is removed from the casing.

### SUMMARY OF THE INVENTION

The present invention relates to a motor casing that includes a first half and a second half which is connected to the first half along a longitudinal direction of the motor casing. A stator and a rotor with a commutator are received in a space enclosed by the first and second halves. A shaft is connected to a driving shaft on the rotor. Two recesses are defined in the second half and face the first half, two sets of brush units are received in the two recesses. A brush cover is connected to the first half and two distal ends of the brush cover seal the two recesses.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional motor casing and the motor received in the conventional motor casing;

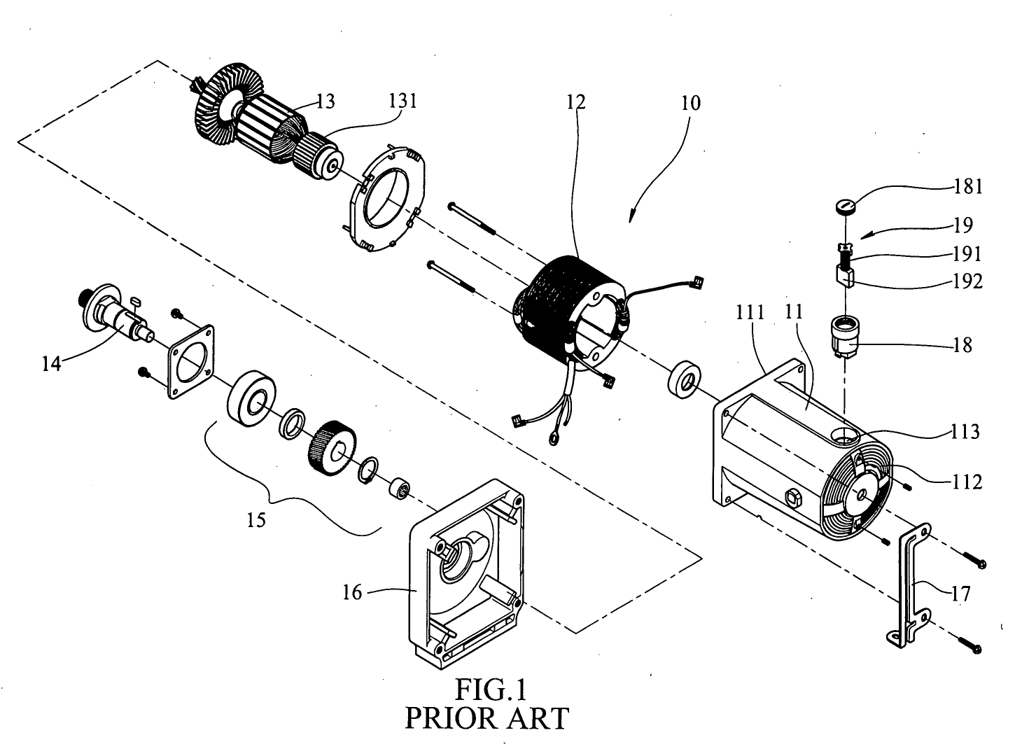

FIG. 2 is a side cross sectional view to show the conventional motor casing and the motor received in the conventional motor casing;

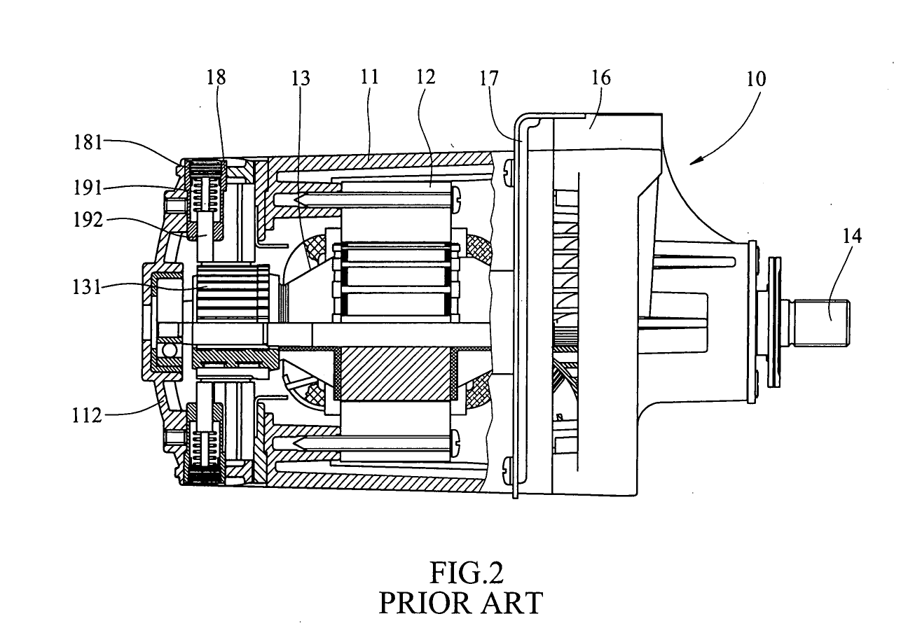

FIG. 3 is an exploded view to show the motor casing of the present invention and the motor received in the motor casing of the present invention;

FIG. 4 is a side cross sectional view to show the motor casing of the present invention and the motor received in the motor casing of the present invention;

FIG. 5 shows the motor casing of the present invention with the motor received therein are used with a table saw, and

FIG. 6 is an exploded view to show the two halves of the motor casing and the brush cover.

### DETAILED DESCRIPTION OF THE PREFERRED EMBODIMENT

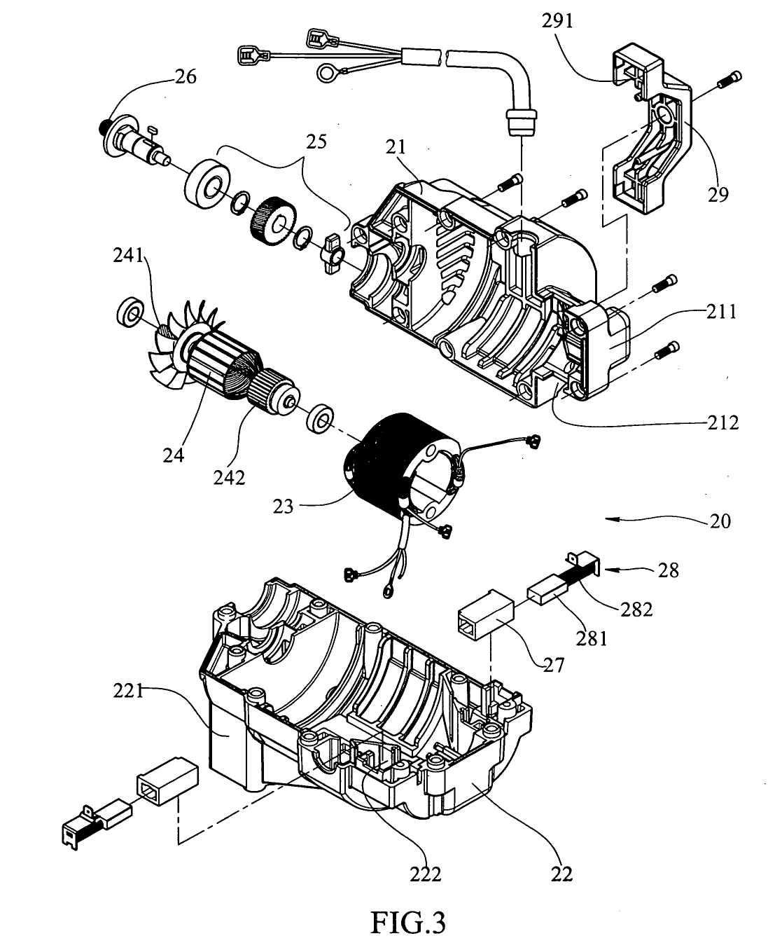

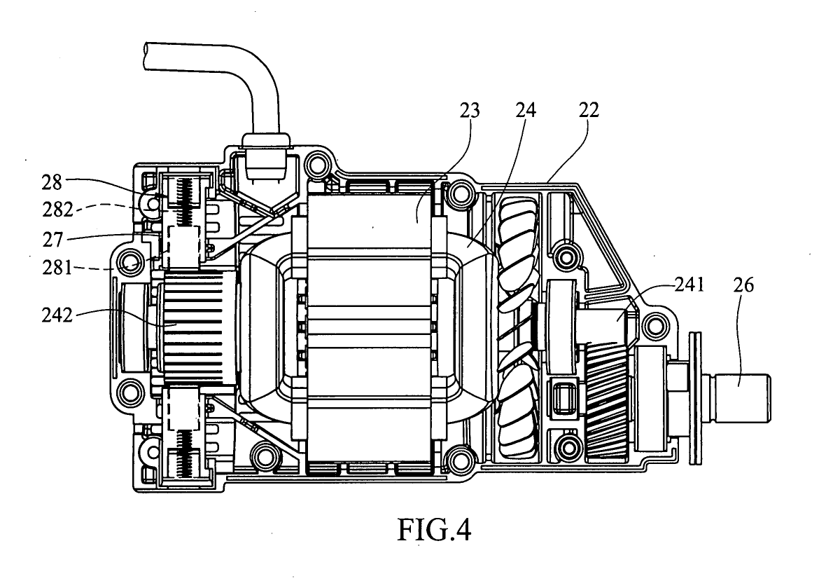

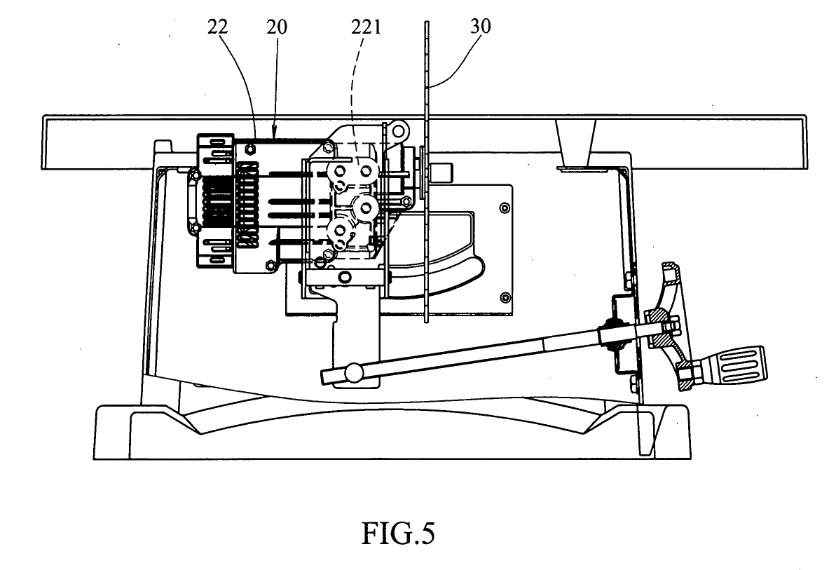

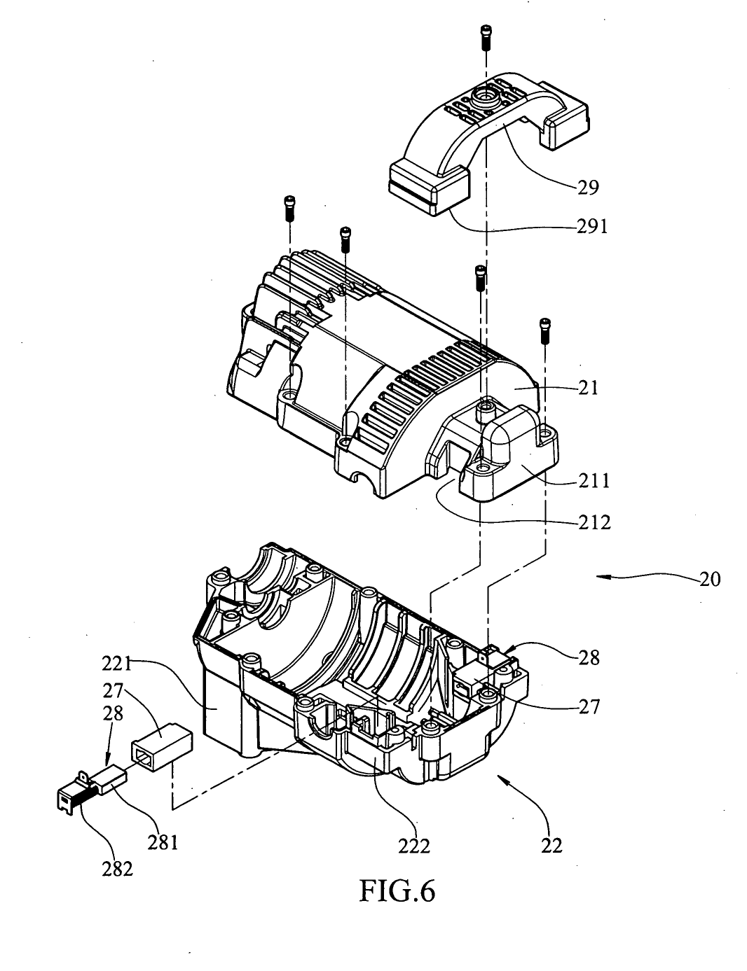

Referring to FIGS. 3 to 6, the motor casing 20 of the present invention comprises a first half 21 which has a rear end connection port 211 extending from a rear end thereof and two notches 212 are defined between the rear end connection port 211 and the end of the first half 21. A second half 22 is connected to the first half 21 along a longitudinal direction of the motor casing 20. A front connection port 221 is connected to the front end of the second half 22 so as to connect the motor casing 20 to a power tool as shown in FIG. 5. A stator 23 and a rotor 24 with a commutator 242 are received in a space enclosed by the first and second halves 21, 22, a shaft 26 connected to a driving shaft 241 on the rotor 24. The blade 30 of the power tool is connected to the shaft 26. Two recesses 222 are defined in the second half 22 and face the first half 21. The two recesses 222 are located on the same plane. Two sets of brush units 28 are received in the two recesses 222 and each set includes a brush housing 27 and a brush unit 28 including a brush 281 with a brush spring 282. The brush 281 is in contact with the commutator 242 on the rotor 24 to generate electric current.

A brush cover 29 is a substantial U-shaped member and a bolt extends through a hole in a middle of the brush cover 29 and is connected to the first half 21. Two distal ends 291 of the brush cover 29 seal the two recesses 222 to cover the two sets of brush units 28. It is noted that the two distal ends 291 of the brush cover 29 are engaged with the two notches 212 which are in alignment with the recesses 222.

When maintaining, the users may easily remove the brush cover 29 from the casing 20 and the first half 21 is conveniently separated from the second half 22. The two sets of brush units 28 are accessible simultaneously. By the motor casing 20, the separable two halves 21, 22 allows the assemblers to conveniently install all the parts in the casing 20, the two sets of brush units 28 are accessible simply removing the brush cover 29.

While we have shown and described the embodiment in accordance with the present invention, it should be clear to those skilled in the art that further embodiments may be made without departing from the scope of the present invention.

What is claimed is:

1. A motor casing comprising:
a first half;
a second half which is connected to the first half along a longitudinal direction of the motor casing, a stator and a rotor with a commutator received in a space enclosed by the first and second halves, a shaft connected to a driving shaft on the rotor, two recesses defined in the second half and facing the first half, two sets of brush units received in the two recesses, and
a brush cover connected to the first half and two distal ends of the brush cover sealing the two recesses.

2. The motor casing as claimed in claim 1, wherein a rear end connection port connected to an end of the first half and two notches defined between the rear end connection port and the end of the first half, the two distal ends of the brush cover engaged with the two notches which are in alignment with the recesses.

3. The motor casing as claimed in claim 2, wherein the brush cover is a substantial U-shaped member and a bolt extends through a hole in a middle of the brush cover and is connected to the first half.

4. The motor casing as claimed in claim 1, wherein the two recesses in the second half are located on the same plane.

5. The motor casing as claimed in claim 1, wherein the second half has a front connection port which is adapted to be connected to a power tool.
